(19) United States
(12) Patent Application Publication
(10) Pub. No.: US 2003/0093871 A1
(43) Pub. Date: May 22, 2003

(54) Closure assembly

(76) Inventor: Andrew C. Edlin, Queensland (AU)

Correspondence Address: HOFFMAN WASSON & GITLER, 2361 JEFFERSON DAVIS HIGHWAY, SUITE 522, ARLINGTON, VA, 22202

(21) Appl. No.: 09/926,757

(22) PCT Filed: Apr. 12, 2001
(86) PCT No.: PCT/AU01/00427

(30) Foreign Application Priority Data
Apr. 13, 2000 (AU) PQ 6893

(51) Int. Cl. B60B 33/04

(52) U.S. Cl. 16/19

(57) ABSTRACT

A closure assembly including an outer and an inner frame (11.16); and a frame hinge (23) including a first frame hinge member having a generally cylindrically shaped bead associated with one of said frames and a second frame hinge member having a complementary socket associated with the other of said frames, at least one frame includes a flange spaced apart from the frame hinge member associated with the at least one frame to cooperate with said frame hinge member to prevent disengagement of said frame hinge member from the other frame hinge member in a closed condition. The assembly also includes a latch (60) hingedly mounted on the outer frame by a hinge having a generally cylindrically shaped bead associated with the latch and a complementary socket associated with the outer frame, the latch including a latch flange spaced apart from the bead to cooperate with a flange (86) on the inner frame to prevent disengagement of the bead from the socket and retain the inner frame in a closed condition.

The present invention relates to a closure assembly. In particular, the present invention relates to a closure assembly incorporating a releasable lock.

The closure assembly has particular, but not exclusive, application to a security screen assembly for doors and window openings. For illustrative purposes, reference throughout the description will be made to such applications. However, it is to be understood that this invention could be used in other applications, such as a window or door assemblies having panel-like closures or light weight flyscreens as well as a closure assembly for selectively closing other openings.

Hinged closures, window frames, insect proof screens and security screens typically include an outer frame constructed from either wood or aluminium to which an inner frame is hinged by means of leaf hinges. The inner frame may provide support for a mesh like material, a panel or a plurality of obstacles such as bars. Various latching mechanisms and extendable locking mechanisms are also known for securing the inner frame to the outer frame.

We have now found that by associating elements of a bead-in-socket hinge with each of the inner and outer frames of a closure assembly in combination with the use of flange abutting the hinge the inner frame may be mounted pivotally on the outer frame and provide for the closure of the assembly in a secure manner. Accordingly, in one aspect the present invention provides a closure assembly including:

an outer frame;

an inner frame; and

a frame hinge, wherein the frame hinge includes a first frame hinge member having a generally cylindrically shaped bead associated with one of said frames and a second frame hinge member having a complimentary socket associated with the other of said frames, and wherein at least one frame includes a flange spaced apart from the frame hinge member associated with the at least one frame and positioned to cooperate with said frame hinge member to prevent disengagement of said frame hinge member from the other frame hinge member in a closed condition. We have also found that by associating elements of a bead-in-socket hinge for hingedly attaching a latch to the outer frame with the latch and the outer frame respectively in combination with a flange on the latch, which flange engages a corresponding flange on the inner frame such that the latch retains the flange on the inner frame in abutment with the hinge to provide a secure closure of the assembly.

In a second aspect of the present invention there is provided a closure assembly including:

an outer frame;

an inner frame hingedly mounted thereon; and

a latch, said latch hingedly mounted on the outer frame by a hinge wherein the hinge includes a first hinge member having a generally cylindrically shaped bead associated with the latch and a second hinge member having a complimentary socket associated with the outer frame, and wherein the latch includes a latch flange spaced apart from the bead and positioned to cooperate with a flange on the inner frame to prevent disengagement of the bead from the complimentary socket and retain the inner frame in a closed condition.

We have also found that by combining the first and second aspects of the present invention the outer frame may be formed from sections of a single extrusion. In a third aspect of the present invention there is provided a closure assembly including:

an outer frame;

an inner frame;

a frame hinge, wherein the frame hinge includes a first frame hinge member having a generally cylindrically shaped bead associated with one of said frames and a second frame hinge member having a complimentary socket associated with the other of said frames, and wherein at least one frame includes a flange spaced apart from the frame hinge member associated with the at least one frame and positioned to cooperate with said frame hinge member to prevent disengagement of said frame hinge member from the other frame hinge member in a closed condition; and

a latch, said latch hingedly mounted on the outer frame by a latch hinge wherein the latch hinge includes a first latch hinge member having a generally cylindrically shaped bead associated with the latch and a second latch hinge member having a complimentary socket associated with the outer frame, and wherein the latch includes a latch flange spaced apart from the bead and positioned to cooperate with a flange on the inner frame to prevent disengagement of the bead from the complimentary socket and retain the inner frame in a closed condition; wherein said outer frame is formed from sections of a single extrusion.

The inner frame preferably provides support for barrier means that may include a sheet of glass or a plurality of obstacles such as a plurality of bars. Preferably, the barrier means includes a sheet of a mesh like material. The inner frame may be constructed from a plurality of frame elements, such as a plurality of castings or extruded sections. Preferably the inner frame is constructed from a hinging element incorporating a frame hinge member, a latching element and further elements wherein the elements are adapted to engage adjacent elements on the inner frame.

In the first aspect of the present invention the inner frame may be retained in a closed position relative to the outer frame by any convenient means. The inner frame may be retained by retaining means which may include various tradition locks and/or latches. However it is preferred that the retaining means includes an elongate latching member that is engagable along substantially the length or width of the closure assembly. The latching member may be pivotally connected to a frame member of either the inner frame or the outer frame wherein the latching member is adapted to engage a catch, groove or recess associated with an adjacent frame member of the outer frame or the inner frame respectively.

In the second aspect of the present invention the inner frame may be hingedly mounted on the outer frame by any convenient means. The inner frame may be hingedly mounted on the outer frame by traditional hinges integral or attached to the frames. It is preferred that the hinged mounting extends engagable along substantially the length or width of the closure assembly.

In a preferred embodiment of the present invention the inner frame is constructed from a hinging element incorporating a frame hinge member having a generally cylindrically shaped bead associated therewith, a latching element having a flange for cooperation with a flange on the latch to prevent disengagement of the bead from the complimentary socket and retain the inner frame in a closed condition and further elements wherein the elements are adapted to engage adjacent elements on the inner frame. In the preferred embodiment the latching element preferably includes a guard which extends from the proximal side of an inner frame member to prevent access to the latch from the distal side of the closure assembly.

The inner frame includes flange adapted to cooperate with the latch flange to prevent disengagement of the bead from the complimentary socket and retain the inner frame in a closed condition. Preferably the flange on the inner frame is a U-shaped flange into which the latch flange is inserted in the closed condition.

The outer frame may be constructed from a plurality of frame members, such as a plurality of castings or extruded sections. Preferably the outer frame is constructed from a single extrusion having a substantially symmetrical profile about its longitudinal axis. The symmetrical profile permits the extrusion to be reversed in order to provide a frame hinge member on the proximal side for cooperation with the other frame hinge member on the outer frame and a flange on the proximal side of the outer frame whereby the flange cooperates with the frame hinge member to prevent disengagement of said frame hinge member from the other frame hinge member in a closed condition and provides protection for the hinge from attack from the distal side of the closure assembly. Preferably all frame elements have similar distal profiles so as to conceal the location of the frame hinge and the latch.

In the preferred embodiment of the present invention the outer fame is formed from an extrusion in which complimentary sockets for each of the generally cylindrically shaped beads of the hinge element of the inner frame and the latch are positioned on the inner wall of one side of the extrusion. In the embodiment the extrusion may be oriented to provide a complimentary socket for the hinge element of the inner frame on the distal side of the closure assembly. The same extrusion may be reversed such that it is oriented to provide a complimentary socket for the latch on the proximal side of the closure assembly.

The outer frame is preferably adapted for mounting on a generally “U” shaped track. It is preferred the outer frame includes a mount having two opposing appendages, each of which having a cavity formed therein in which a connector, such a screw, used to interconnect the generally “U” shaped track to an adjacent frame member may be retained, each of said appendages being capable of separate location within the “U” shaped track, said appendages being separated by an open channel.

The cylindrically shaped bead for use with either the frame hinge or the latch hinge of the first, second or third aspects of the present invention may preferably extend along substantially all of one side of the frame or latch. However, it falls within the scope of the present invention to use a plurality of cylindrically shaped beads that extend along one side of the frame or latch.

The complimentary socket for use with either the frame hinge or the latch hinge of the first, second or third aspects of the present invention may preferably extend along substantially all of one side of the frame or frames. However, it falls within the scope of the present invention to use a plurality of complimentary sockets that extend along one side of the frame or latch.

Advantageously, the present invention may provide a closure assembly having integral hinge members, which assembly does not require hinges to be screwed in place. The present invention, in certain embodiments, may conceal the location of the hinges to persons looking at the closed window frame from the distal side of the closure assembly. Furthermore, the construction of many frame assemblies according to the present invention may provide protection for the hinges when the window frame is closed, or prevent persons from inserting a lever between the adjacent hinged edge portions of the outer frame and the inner frame.

Advantageously the present invention is readily adaptable to provide hinging and latching of the inner frame to the outer frame which extends along the entire length or width of the closure assembly providing a securing closure assembly by eliminating weak points which exist along the length of the frame, particularly if only one or two locking mechanisms are used.

In order that this invention may be more easily understood and put into practical effect, reference will now be made to the accompanying drawings that illustrate a preferred embodiment of the invention:

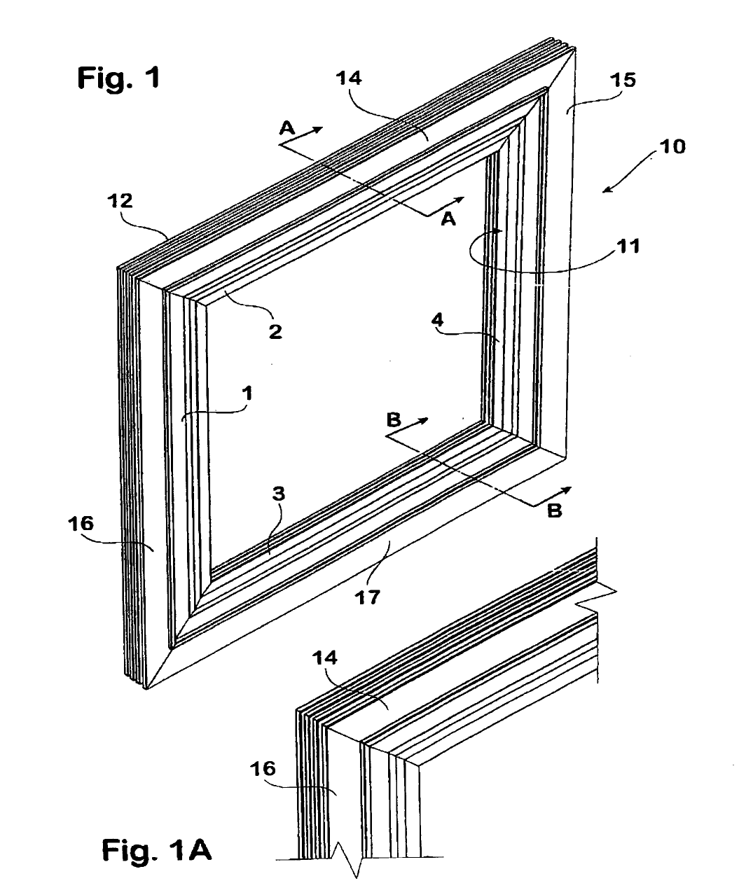

FIG. 1 is a pictorial view showing the external side of a closure assembly constructed in accordance with the present invention;

FIG. 1a is a pictorial view showing a close up of the corner of the external side of the closure assembly of FIG. 1.

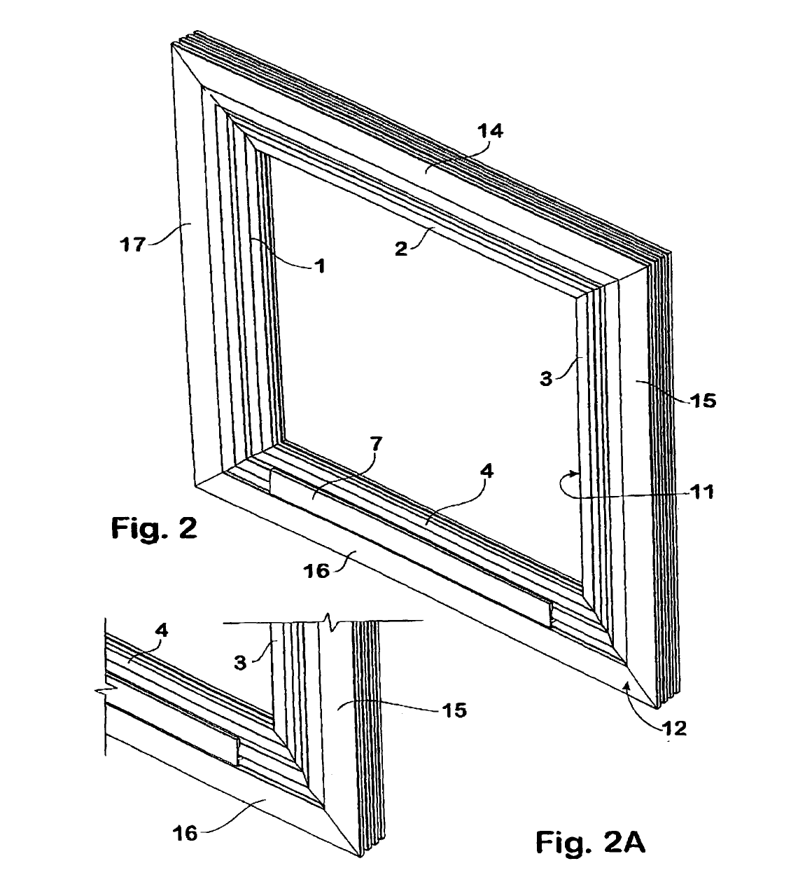

FIG. 2 is a pictorial view showing the internal side of the closure assembly illustrated in FIG. 1;

FIG. 2a is a pictorial view of a close up of the internal side of the closure assembly of FIG. 2;

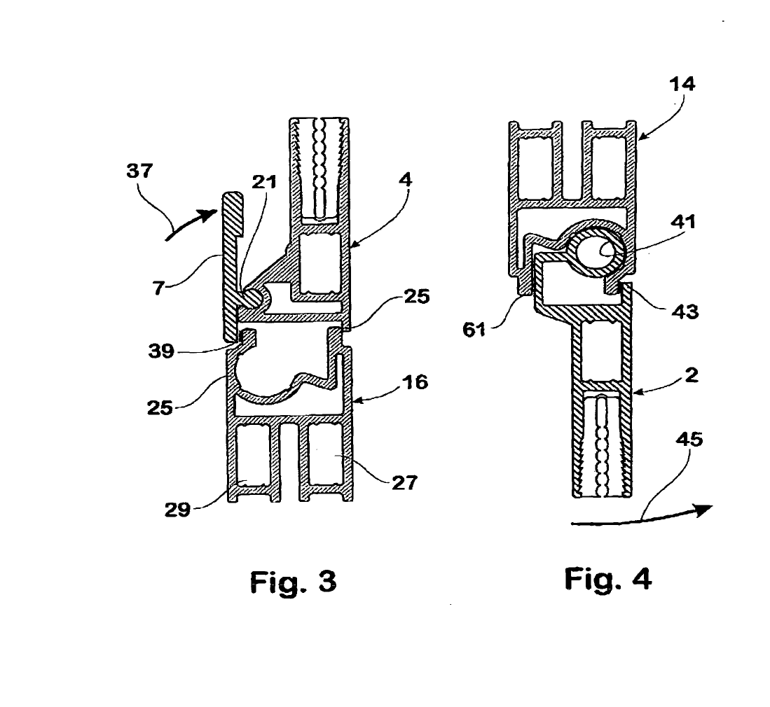

FIG. 3 is a transverse cross-sectional view of the latch closure assembly on the bottom of the illustrated in FIG. 2;

FIG. 4 is a transverse cross sectional view of the hinge assembly on the top of the closure assembly illustrated in FIG. 2.

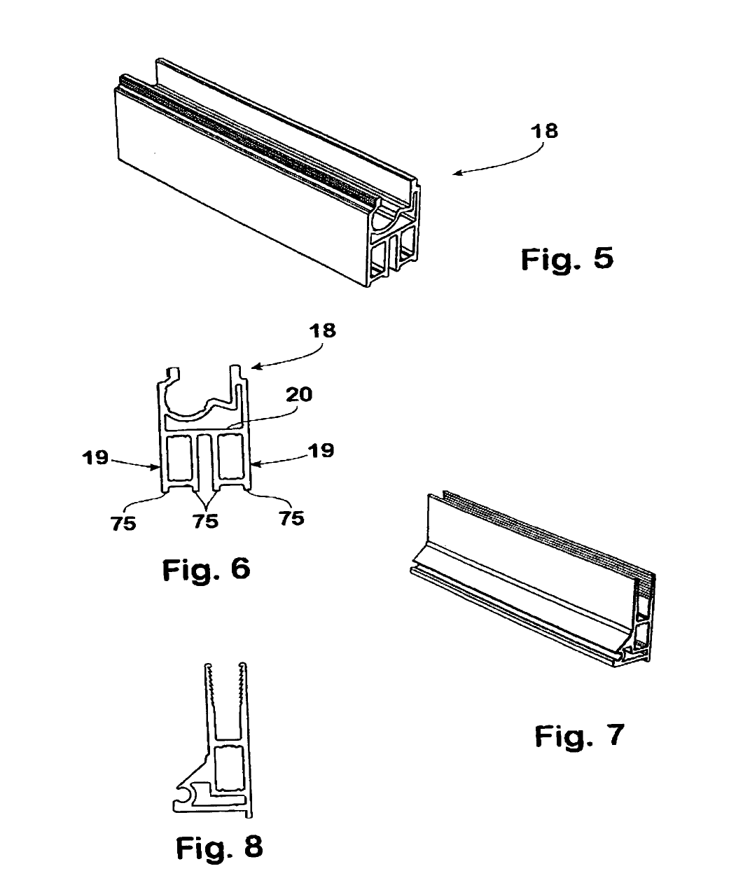

FIG. 5 is a pictorial view of the external frame shown in transverse cross section in FIGS. 3 and 4;

FIG. 6 is a transverse cross sectional view of the extrusion represented in FIG. 5;

FIG. 7 is a pictorial view of the latching frame member of the inner frame;

FIG. 8 is a transverse cross sectional view of the frame member shown in FIG. 7;

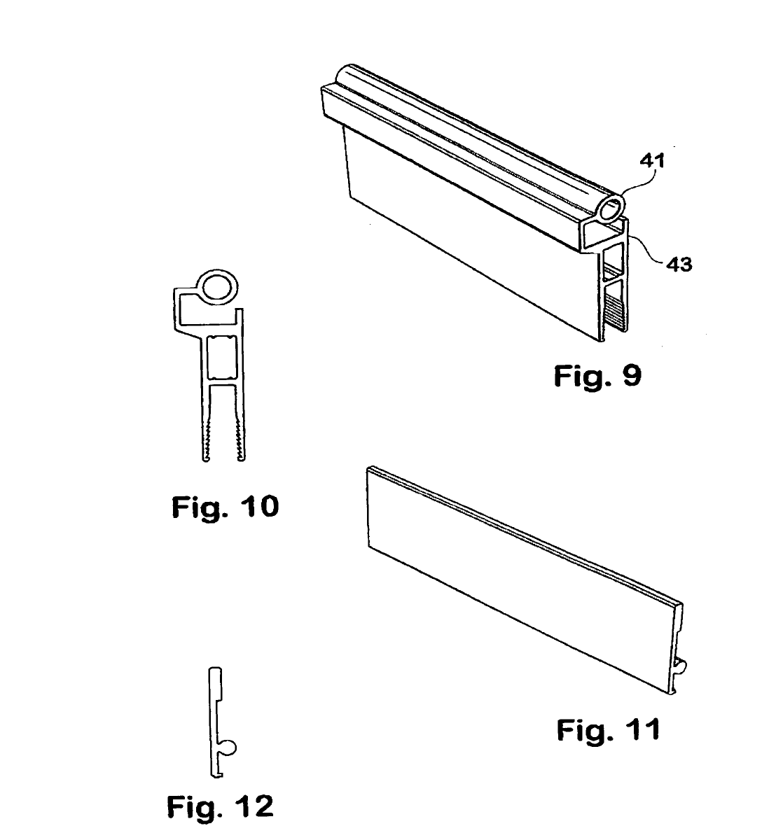

FIG. 9 is a pictorial view of the inner frame member that provides hinged engagement with the corresponding outer frame member as shown in FIG. 4;

FIG. 10 is a transverse cross sectional view of the inner frame member shown in FIG. 9;

FIG. 11 is a pictorial view of the latch member shown in FIG. 3;

FIG. 12 is a transverse cross section of the latch member shown in FIG. 11.

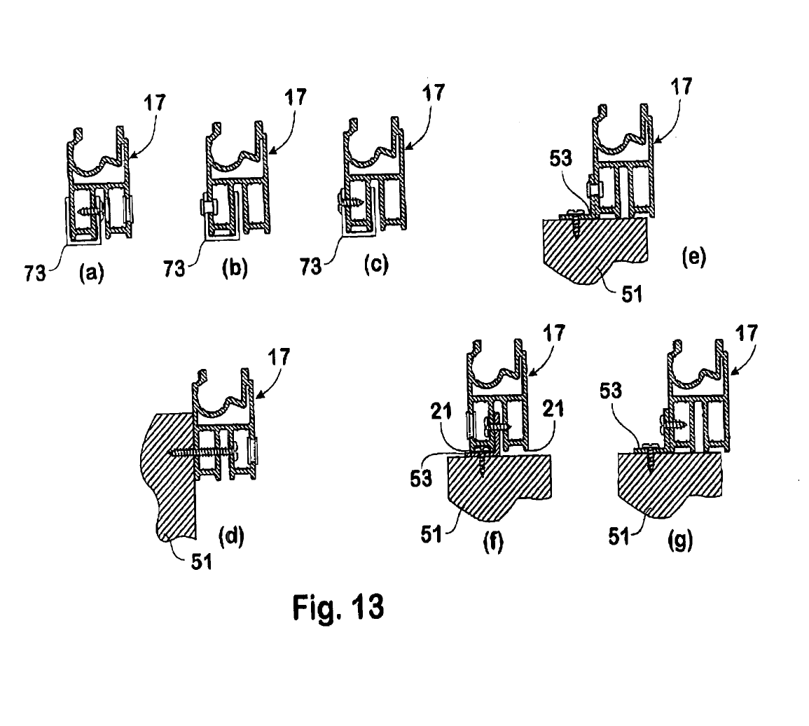

FIGS. 13(a), (b) and (c) depict the attachment of a section of the outer frame member to a flyscreen channel;

FIG. 13(d) depicts the attachment of a section of the outer frame member directly to a window surround, and

FIG. 13(e), (f) and (g) depict the attachment of a section of the outer frame member to a window surround by means of an “L” shaped section.

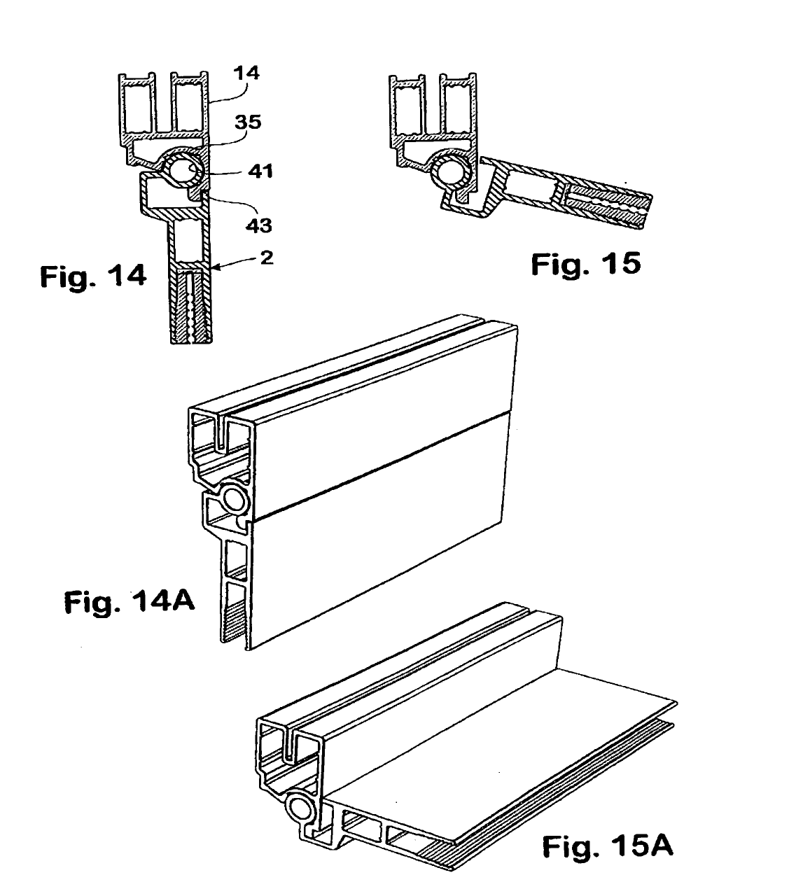

FIG. 14 shows a transverse cross sectional view of the hinged connection between the inner and outer frames of another embodiment of the invention;

FIG. 15 shows a transverse cross sectional view of the inner and outer frames of FIG. 14 in the open position;

FIGS. 14a and 15a are pictorial views of the extrusions illustrated in FIGS. 14 and 15 respectively;

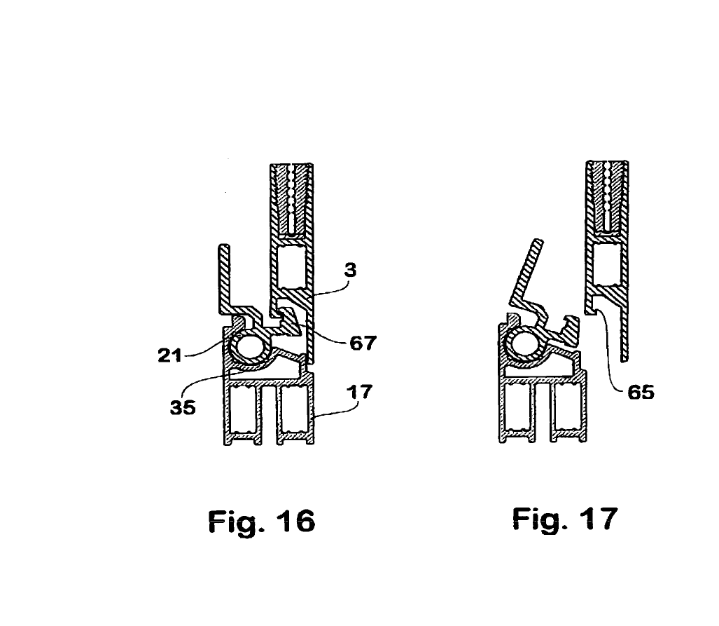

FIG. 16 is a transverse cross sectional view of the latching engagement of the inner and outer frames;

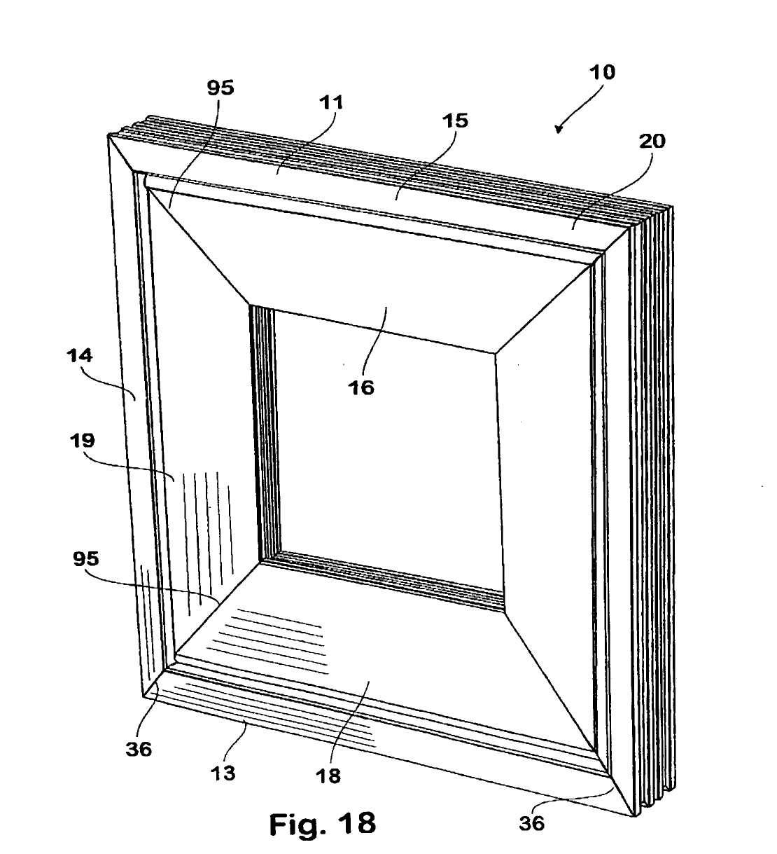

FIG. 17 is a transverse cross sectional view of the inner and outer frames shows in FIG. 16 in the open position;

FIG. 18 is a pictorial view of the external side of a closure assembly of the invention;

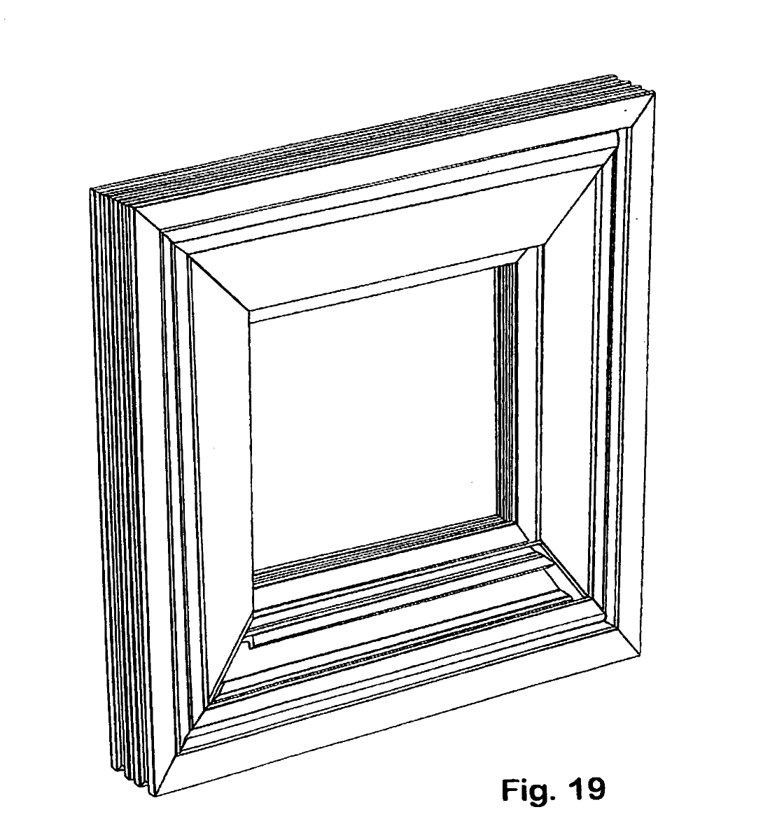

FIG. 19 is a pictorial view of the internal side of the closure assembly in accordance with the invention;

FIG. 20 is a cut away view of the closure assembly shown in FIG. 19;

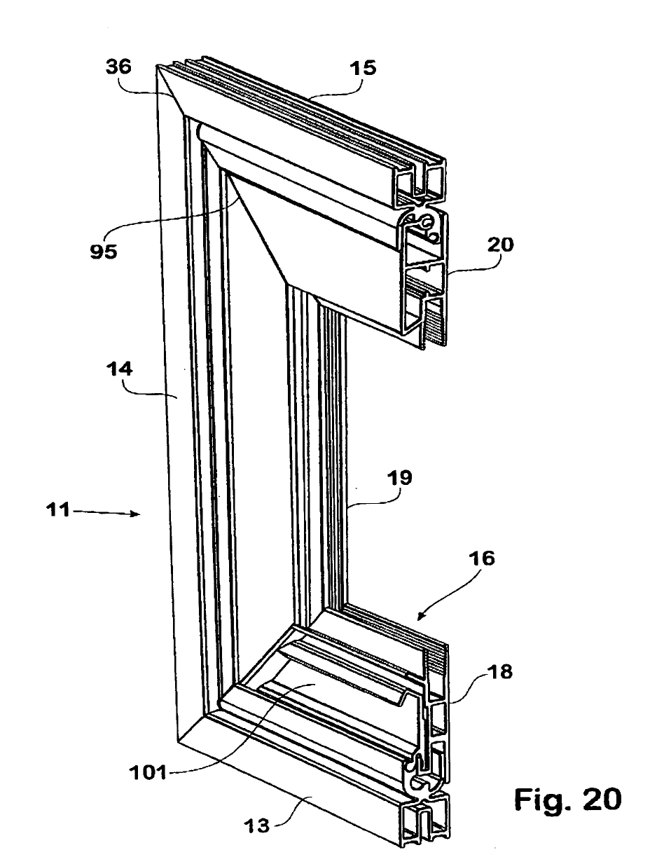

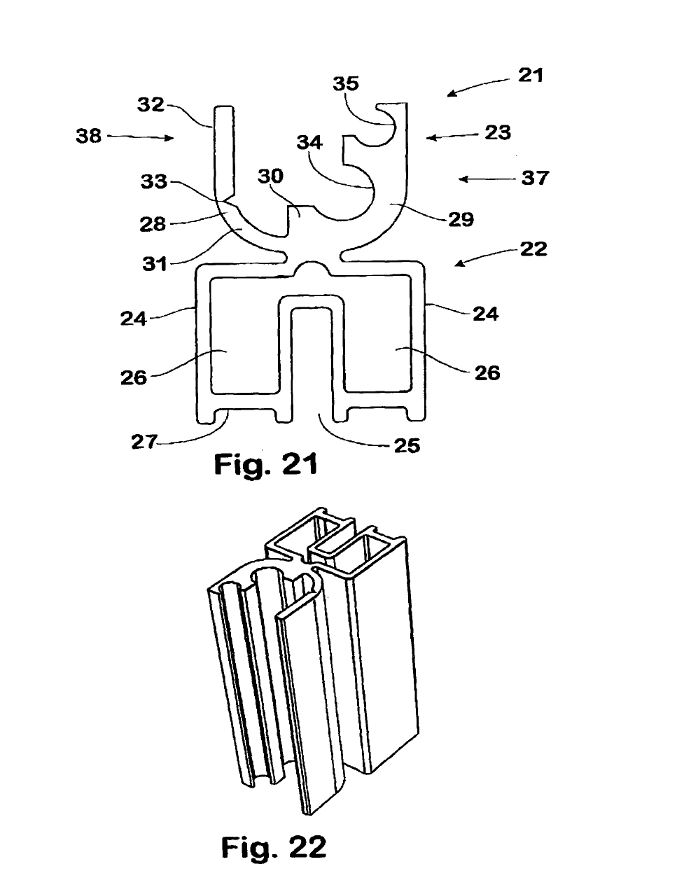

FIG. 21 is a transverse cross sectional view of the external frame members of the closure assembly shown in FIGS. 18, 19 and 20;

FIG. 22 is a pictorial view of the external frame shown in FIG. 21;

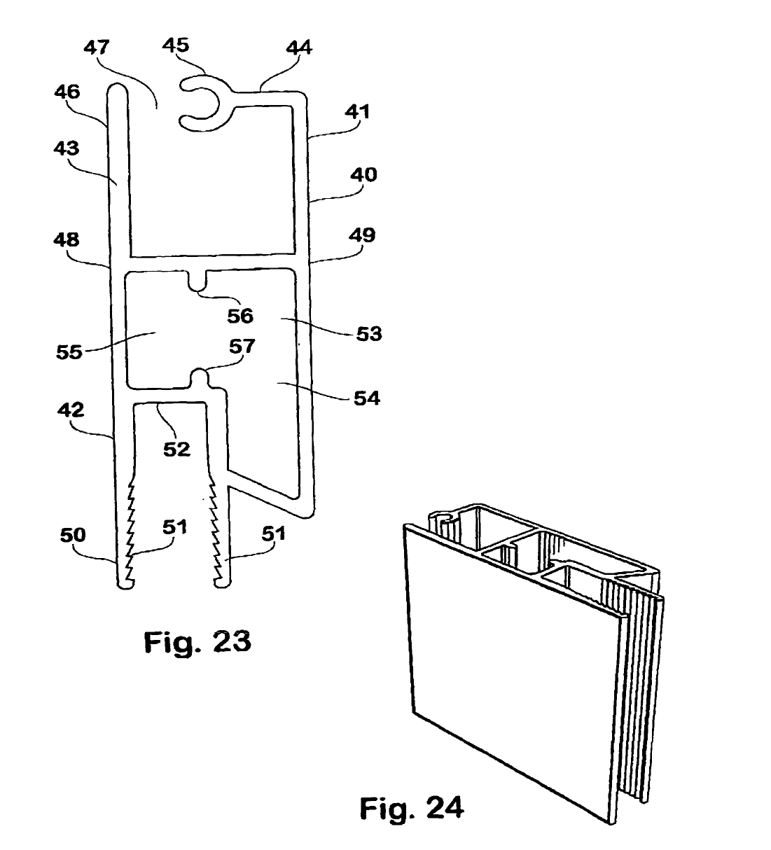

FIG. 23 is a transverse cross sectional view of the frame member of the inner frame that hingedly engages the external frame shown in FIG. 20;

FIG. 24 is a pictorial view of the extrusion shown in FIG. 23;

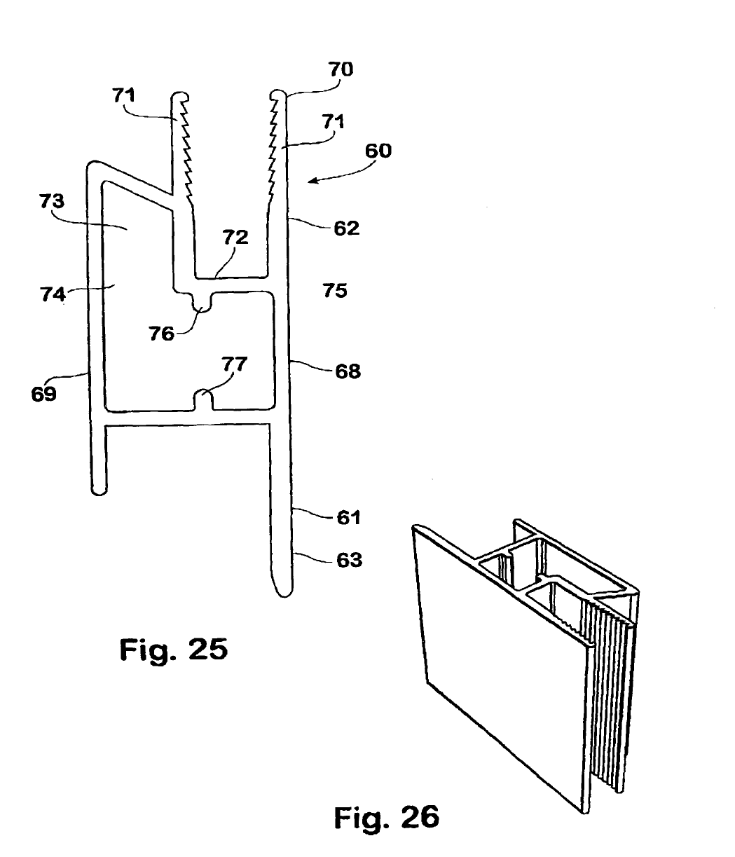

FIG. 25 is a transverse cross sectional view of the side members of the inner frame;

FIG. 26 is a pictorial view of the extrusion shown in FIG. 25;

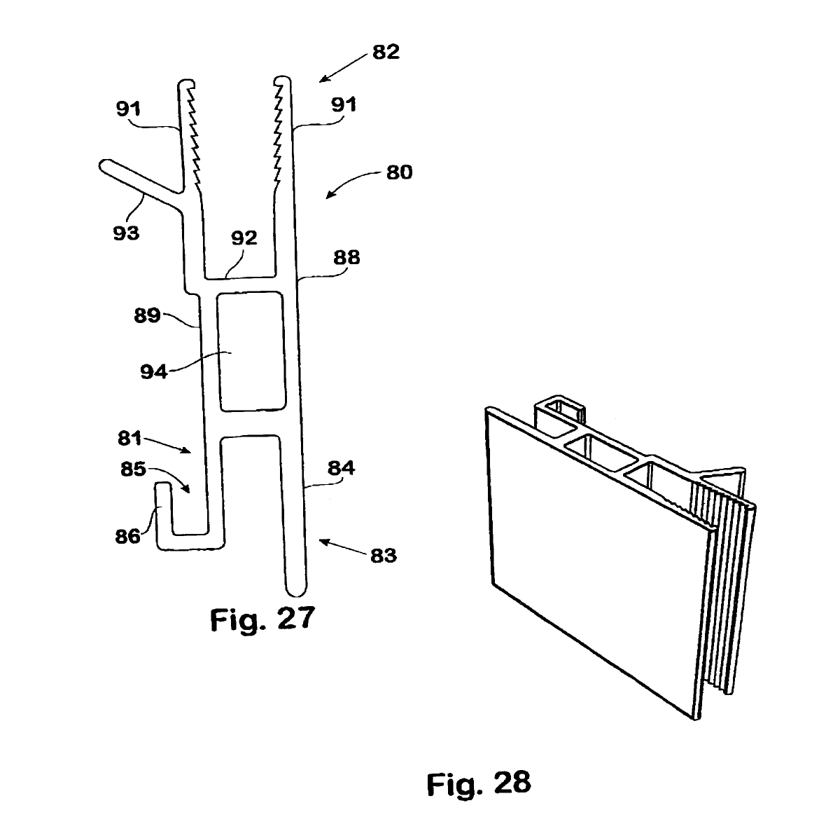

FIG. 27 is a transverse cross sectional view of the inner frame member that is latched to the outer frame member as shown in FIG. 20;

FIG. 28 is a pictorial view of the extrusion of FIG. 27;

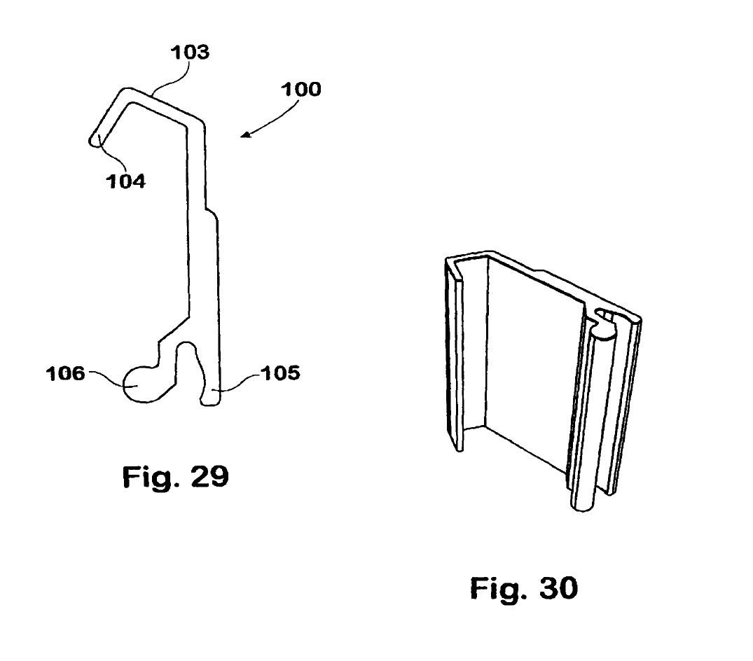

FIG. 29 is a transverse cross sectional view of the latch member shown in FIG. 20;

FIG. 30 is a pictorial representation of the extrusions shown in FIG. 29;

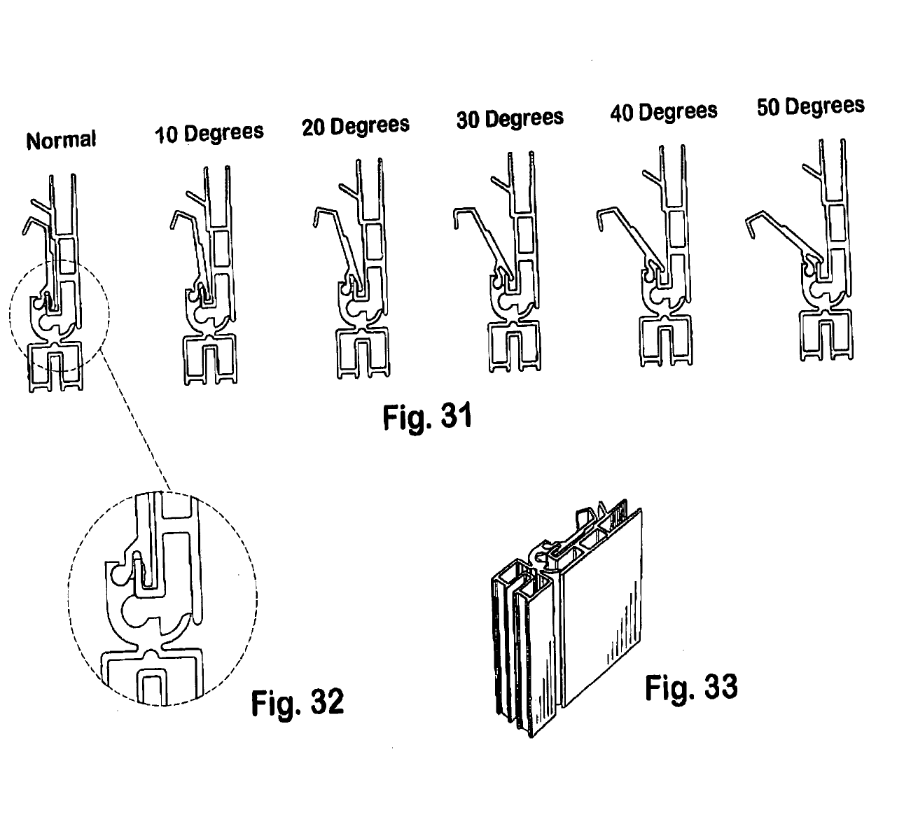

FIGS. 31a, b, c, d, e, and f show the operation of the latching engagement of the inner and outer frame members shown in FIG. 20;

FIG. 32 is a transverse cross sectional representation of the latching assembly;

FIG. 33 is a pictorial representation of the latching assembly shown in FIG. 32;

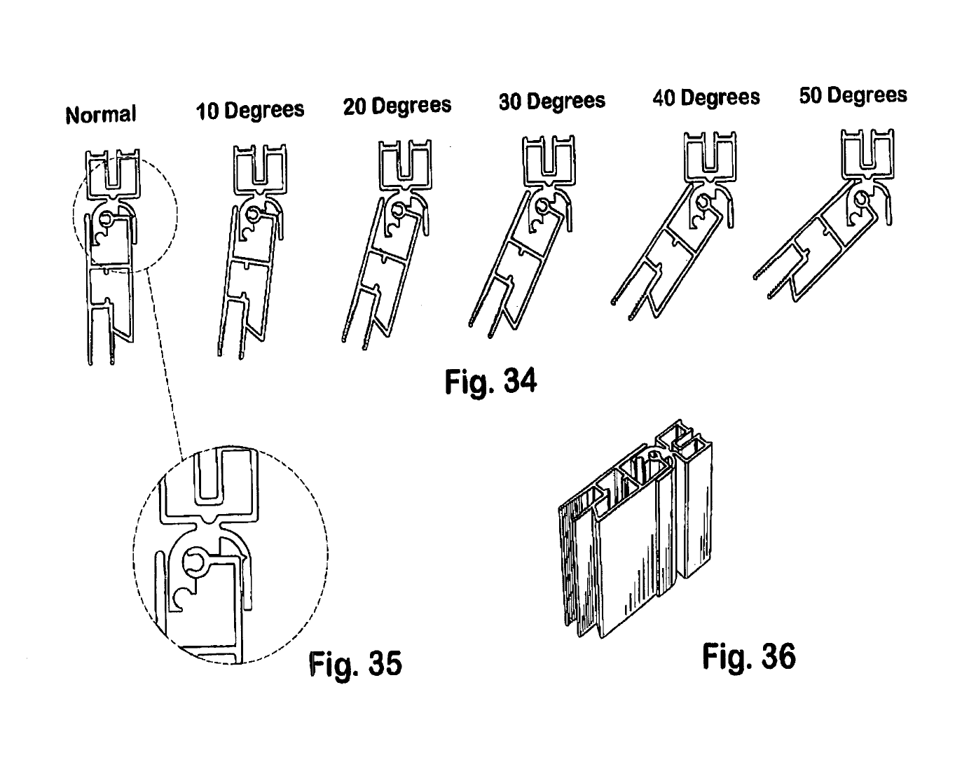

FIGS. 34a, b, c, d, e and f show the operation of the hinged engagement of the inner and outer frames shown in FIG. 20;

FIG. 35 shows a transverse cross sectional view of the hinged assembly;

FIG. 36 shows a pictorial view of the hinged assembly of FIG. 35.

FIGS. 18 to 20 show a closure assembly 10 that includes an outer frame 11 consisting of four outer frame members 12, 13, 14 and 15. The outer frame 10 surrounds an inner frame 16 that consists of four inner frame members 17, 18, 19 and 20. The inner frame 16 may provide support for an infill material, such as a sheet of a mesh like material, that in use shall prevent access to the opening defined by the outer frame 11.

The outer frame members 12, 13, 14 and 15 are each cut from an extruded section 21 of aluminium, as illustrated in FIGS. 21 and 22. The section 21 includes a mounting portion 22 and a hinge portion 23.

The mounting portion 22 includes two substantially rectangularly shaped, thin walled, appendages 24 that are separated by a channel 25. The appendages each define a rectangularly shaped tubular bore 26. The distal end of each appendage 24 includes a shallow recess 27 that extends along the length of the extrusion.

The hinge portion 23 includes two opposing arms 28 and 29 that extend outwardly from a central portion 30. The arm 28 includes a first or arcuate portion 31 that is connected to a second or distal straight portion 32 by an intermediate section 33 of reduced thickness.

The arm 29 includes two generally cylindrically shaped recesses or sockets 34 and 35 that each open into the interior of the extrusion 21.

In addition, it should be noted that the external profile of the two sides 37 and 38 of the extrusion are visually substantially identical.

The outer frame members 12, 13, 14 and 15 each include mitred end portions 36 and wherein abutting adjacent end portions are interconnected by “L” shaped stakes, not shown, that include two divergent end portions that are adapted to frictionally locate within a respective tubular bore 26. In this regard it should be noted that while the same extrusion has been used to manufacture outer frame members 12, 13, 14 and 15, the outer frame 13 has been inverted and wherein the inclusion of two tubular bores 26 allows the frame member to be interconnected to adjacent frame members 12 and 14.

FIGS. 23 and 24 show an extruded section 40 of aluminium from which the hinged inner frame member 20 is constructed. The extruded section 40 includes two opposing side walls 48 and 49 that interconnect a hinge portion 41 and a mounting portion 42. The hinge portion 41 includes a substantially rectangular shaped box section 43 having an end wall 44 that includes a “C” shaped plug 45. The plug 45 faces a side wall 46 and wherein there exists a gap 47 therebetween.

The mounting portion 42 includes a “U” shaped channel section 50 consisting of two opposing side walls 51 that are interconnected by an intermediate web portion 52. The inside faces of the two side walls 51 are serrated.

The extruded section 40 also includes an internal cavity 53 that is divided into two parts 54 and 55 by two opposing flanges 56 and 57.

FIGS. 25 and 26 show an extruded section 60 of aluminium from which the two side inner frame members 17 and 19 are constructed. The extruded section 60 includes two opposing side walls 68 and 69 that interconnect a mounting portion 62 and an edge portion 61. The edge portion consists of a substantially “J” shaped channel section that includes a straight wall portion 63.

The mounting portion 62 includes a “U” shaped channel section 70 consisting of two opposing side walls 71 that are interconnected by an intermediate web portion 72. The inside faces of the two side walls 71 are serrated.

The extruded section 60 also includes an internal cavity 73 that is divided into two parts 74 and 75 by two opposing flanges 76 and 77.

FIGS. 27 and 28 show an extruded section 80 of aluminium from which the latch engaging inner frame member 18 is constructed. The extruded section 80 includes two opposing side walls 88 and 89 that interconnect a latch engaging portion 81 and a mounting portion 82. The latch engaging portion 81 includes a substantially “J” shaped channel section 83 that includes a straight wall portion 84. The latch engaging portion also includes a “U” shaped channel 85 defined by a return flange 86.

The mounting portion 82 includes a “U” shaped channel section 90 consisting of two opposing side walls 91 that are interconnected by an intermediate web portion 92. The inside faces of the two side walls 91 are serrated. The mounting portion also includes an inclined flange or guard 93 that extends outwardly from one of the walls 91.

The extruded section 80 also includes a rectangularly shaped internal cavity or bore 94.

The inner frame members 17, 18, 19 and 20 each include mitred end portions 95 and wherein abutting adjacent end portions are interconnected by “L” shaped stakes, not shown, that include two divergent end portions that are adapted to frictionally locate within a respective tubular bore 55, 75 or 94.

FIGS. 29 and 30 shows an extruded section 100 of aluminium from which a latching member 101 is constructed. The extruded section 100 includes a handle 103 which itself includes a flange 104.

The opposite end of the latching member 101 includes a catch or flange 105 that is located adjacent a substantially cylindrically shaped plug 106.

In use, the outer and inner frames 11 and 16 respectively are assembled in the manner as previously described above and wherein disassembly is prevented by crimping the metal surrounding each stake, such as by stamping same with the circular shaped end of a punch.

Then the distal flange portion 32 is separated from the arcuate flange portion 31 of the extruded section 21 used to construct the outer frame member 18. This is achieved by bending the reduced section 33 connection the two portions 31 and 32 several times.

Having removed the flange portion 32, the inner frame 16 can be hingedly connected to the outer frame 11. This is achieved by locating the plug 45 within the complementary shaped socket 34 as illustrated in great detail in FIG. 32.

The inner frame 16 may be selectively retained in a closed position as illustrated in FIGS. 18 to 20 in particular, by the engagement of the catch 105 of the latching member 101 with the channel shaped recess 85. The latching member can pivot between an engaged position and a disengaged position due to the rotation of the plug 106 within the complementary shaped socket 35, as illustrated in greater detail in FIGS. 31a to 31f.

The mounting portions 50, 70 and 90 are each adapted to receive an elongate, “U” shaped fastener, not shown, that itself is adapted to grip an edge portion of a sheet of mesh like material located therebetween. The mesh like material, not shown, is used to close the opening defined by the inner frame 16.

The assembled closure assembly or security screen 10 may be attached to a window opening using a variety of methods. For example, with reference to FIGS. 13(a) to 13(c), the mounting portion 22 of the outer frame member 13 is shown screwed or riveted to a flyscreen channel 110. In FIGS. 13(d) to 13(g) various arrangements are shown for securing the outer frame member 13 to the surrounds 111 of a window opening. As shown in FIGS. 13(e) to 13(g) it may be preferable to make use of an “L” shaped extrusion 112 to facilitate attachment to the surround.

With particular reference to the securing arrangement shown in FIG. 13(f) it will be noted that the recess 27 is adapted to accommodate the head portion of the screw.

With particular reference to FIG. 18, which shows the appearance of the external side of the closure assembly 10, it will be noted that the appearance of the overlapping frame members 17 and 12, 18 and 13, 19 and 14, and 20 and 15 is substantially identical. As a consequence it is difficult to ascertain from looking at the assembly where the inner frame 16 is hingedly connected to the outer frame 11.

Furthermore, with reference to FIG. 33, it can be seen that the hinge is concealed behind the overlapping wall portions 29 and 46. As a consequence, it is believed that it will be more difficult for potential intruders to damage or otherwise interfere with the hinge assembly.

It will also be appreciated that the guard 93 prevents objects that have been extended through the opening of the inner frame 16 from engaging the handle 103 of the latching member with the view to displacing the engaged latching member.

It will of course be realised that the above has been given only by way of illustrative example of the invention and that all such modifications and variations thereto as would be apparent to persons skilled in the art are deemed to fall within the broad scope and ambit of the invention as is herein set forth.

The claims defining the invention are as follows:

1. A closure assembly including:
an outer frame;
an inner frame; and
a frame hinge, wherein the frame hinge includes a first frame hinge member having a generally cylindrically shaped bead associated with one of said frames and a second frame hinge member having a complimentary socket associated with the other of said frames, and wherein at least one frame includes a flange spaced apart from the frame hinge member associated with the at least one frame and positioned to cooperate with said frame hinge member to prevent disengagement of said frame hinge member from the other frame hinge member in a closed condition.

2. A closure assembly according to claim 1 wherein the inner frame provides support for barrier means.

3. A closure assembly according to claim 2 wherein the barrier means is selected from the group consisting of glass sheet, a plurality of bars, mesh-like material.

4. A closure assembly according to any one of claims 1 to 3 wherein the inner frame is retained in a closed position relative to the outer frame by retaining means selected from the group consisting of tradition locks and/or latches.

5. A closure assembly according to any one of claims 1 to 3 wherein the inner frame is retained in a closed position relative to the outer frame by retaining means including an elongate latching member that is engagable along substantially the length or width of the closure assembly.

6. A closure assembly according to claim 5 wherein the latching member is pivotally connected to a frame member of either the inner frame or the outer frame wherein the latching member is adapted to engage a catch, groove or recess associated with an adjacent frame member of the outer frame or the inner frame respectively.

7. A closure assembly including:
an outer frame;
an inner frame hingedly mounted thereon; and
a latch, said latch hingedly mounted on the outer frame by a hinge wherein the hinge includes a first hinge member having a generally cylindrically shaped bead associated with the latch and a second hinge member having a complimentary socket associated with the outer frame, and wherein the latch includes a latch flange spaced apart from the bead and positioned to cooperate with a flange on the inner frame to prevent disengagement of the bead from the complimentary socket and retain the inner frame in a closed condition.

8. A closure assembly according to claim 7 wherein the inner frame is hingedly mounted on the outer frame by hinges integral or attached to the frames.

9. A closure assembly according to claim 7 wherein the hinged mounting extends engagable along substantially the length or width of the closure assembly.

10. A closure assembly including:
an outer frame;
an inner frame;
a frame hinge, wherein the frame hinge includes a first frame hinge member having a generally cylindrically shaped bead associated with one of said frames and a second frame hinge member having a complimentary socket associated with the other of said frames, and wherein at least one frame includes a flange spaced apart from the frame hinge member associated with the at least one frame and positioned to cooperate with said frame hinge member to prevent disengagement of said frame hinge member from the other frame hinge member in a closed condition; and
a latch, said latch hingedly mounted on the outer frame by a latch hinge wherein the latch hinge includes a first latch hinge member having a generally cylindrically shaped bead associated with the latch and a second latch hinge member having a complimentary socket associated with the outer frame, and wherein the latch includes a latch flange spaced apart from the bead and positioned to cooperate with a flange on the inner frame to prevent disengagement of the bead from the complimentary socket and retain the inner frame in a closed condition; wherein said outer frame is formed from sections of a single extrusion.

11. A closure assembly according to claim 10 wherein the inner frame is constructed from a hinging element incorporating a frame hinge member having a generally cylindrically shaped bead associated therewith, a latching element having a flange for cooperation with a flange on the latch to prevent disengagement of the bead from the complimentary socket and retain the inner frame in a closed condition and further elements wherein the elements are adapted to engage adjacent elements on the inner frame.

12. A closure assembly according to claim 11 wherein the latching element includes a guard which extends from the proximal side of an inner frame member to prevent access to the latch from the distal side of the closure assembly.

13. A closure assembly according to any one of claims 10 to 12 wherein the flange on the inner frame is a U-shaped flange into which the latch flange is inserted in the closed condition.

14. A closure assembly according to any one of claims 1 to 13 wherein the outer fame is formed from an extrusion in which complimentary sockets for each of the generally cylindrically shaped beads of the hinge element of the inner frame and the latch are positioned on the inner wall of one side of the extrusion.

15. A closure assembly according to claim 14 wherein the extrusion is oriented to provide a complimentary socket for the hinge element of the inner frame on the distal side of the closure assemblies and wherein the same extrusion is oriented to provide a complimentary socket for the latch on the proximal side of the closure assembly.
